(19) United States
(12) Patent Application Publication
(10) Pub. No.: US 2003/0084575 A1
(43) Pub. Date: May 8, 2003

(54) Structure of a penknife

(76) Inventor: Chun Chiung Chen, Taipei City (TW)

Correspondence Address: CHUN CHIUNG CHEN, P.O. Box 82-144, TAIPEI, 75014, TW

(21) Appl. No.: 09/985,987

(22) Filed: Nov. 7, 2001

(51) Int. Cl. B26B 1/08

(52) U.S. Cl. 30/162; 30/335

(57) ABSTRACT

An improved structure of a penknife is disclosed. The improved structure of a pen-knife of the present invention comprises (a) a top housing and a bottom housing being mounted together with a positioning screw at the center of the housings; (b) a knife seat having a push button and engaging teeth for engaging with a plurality of blade notches at the edge at one end of a blade; and (c) four pairs of engaging recess and engaging button being provided at the four corners of the top housing and bottom housing and being engageable with each other; characterized in that the end section of the top housing is provided with a round protrusion urged by a spring and a round recess is provided on the bottom housing at a position corresponding to the round protrusion, thereby a finger is used to press the rear end of the top housing so that the engaging recess and engaging buttons on the top and bottom housing are separated so that the housings of the front end of the pen-knife are crossed with each other, allowing installation of a blade or removal of a blade.

### BACKGROUND OF THE INVENTION

(a) Field of the Invention

The present invention relates to an improved structure of a penknife, and in particular, a penknife which facilitates the replacement of a cutting blade with only one hand.

(b) Description of the Prior Art

Conventional penknives are shown in FIG. 1 and FIG. 2. FIG. 1 shows a conventional penknife disclosed in Taiwan Patent Publication No. 373563. The conventional structure of penknife needs two hands to proceed with replacement of a cutting blade, and the blade seat holding the cutting blade may be dislocated easily or biased. Therefore, this structure does not expedite the replacement of cutting blade of the penknife.

In another conventional pen-knife (shown in FIGS. 2A and 2B) disclosed in Taiwan Patent Publication No. 395325, the two housings of the pen-knife are fastened to each other at the center section of the pen-knife and the body structure of the pen-knife are mounted together by a fastener. The drawbacks of the present conventional structure are that the pen-knife bodies may be dislocated easily as only the center of the body is mounted and therefore the two-piece body will tend to separate away at both of ends of the body. Another drawback of this conventional structure is that the two bodies have to be separated in order to install a blade therein. However, it is rather time-consuming to fasten the two-piece body after the blade has been installed.

In contrast to the prior art the present invention is a penknife, which allows a rapid installation of a blade if a used blade is to be replaced.

### SUMMARY OF THE INVENTION

Accordingly the present invention has overcome the above-mentioned drawbacks and limitations by providing an improved structure of a penknife, wherein the installation of blade can be implemented with one hand.

Yet another object of the present invention is to provide an improved structure of a penknife, wherein the blade can be replaced with either a rolling blade, a sawing blade or a diamond blade.

Another object of the present invention is to provide an improved structure of a penknife, wherein the installation or replacement of blade can be carried out safely and conveniently.

It is another object of the present invention to provide an improved structure of a penknife, wherein the top and bottom housing of the penknife do not need to be separated in the process of replacing the blade.

An aspect of the present invention is to provide an improved structure of a penknife comprising: a top housing and a bottom housing being mounted together with a positioning screw at the center of the housings; a knife seat having a push button and engaging teeth for engaging with a plurality of blade notches at the edge at one end of a blade; four pairs of engaging recess and engaging button being provided at the four corners of the top housing and bottom housing and being engageable with each other; characterized in that the end section of the top housing is provided with a round protrusion urged by a spring and a round recess is provided on the bottom housing at a position corresponding to the round protrusion, thereby a finger is used to press the rear end of the top housing so that the engaging recess and engaging buttons on the top and bottom housing are separated so that the housings of the front end of the pen-knife are crossed with each other, allowing installation of a blade or removal of a blade.

Additional advantages and novel features of the invention will be set forth in part in the description that follows, and in part will become apparent to those skilled in the art. The advantages of the invention may be realized and attained by means of the drawings.

### BRIEF DESCRIPTION OF THE DRAWINGS

FIG. 1 is a perspective exploded view of a conventional penknife structure disclosed in Taiwan Patent Publication No. 373563.

FIGS. 2A and 2B are sectional views of another conventional penknife structure disclosed in Taiwan Patent Publication No. 395325.

FIG. 3 is a perspective view (side angle) of the penknife of the present invention.

FIG. 4 is a perspective view (front angle) of the penknife of the present invention.

FIG. 5 is a perspective exploded view of the penknife in accordance with the present invention.

FIG. 6 is a partial sectional view of the penknife, showing the blade thereof being extended out, in accordance with the present invention.

FIG. 7 is a schematic view of the penknife structure of the present invention, wherein the blade has not been installed.

FIG. 8 is a schematic view of the penknife structure of the present invention, wherein the blade has been installed.

FIG. 9 is a schematic view of the penknife structure of the present invention, wherein the blade has been installed by inserting the blade into the front end of the structure.

FIG. 10 is a schematic view of the penknife structure of the present invention, wherein the blade has been installed by pushing the blade into the front end of the structure.

FIG. 11 is a schematic view showing a separation of the housing of the penknife of the present invention by a single hand.

FIG. 12 is a schematic view showing the application of the pen-knife (in cutting paper) with a single hand in accordance with the present invention

FIG. 13 is a schematic view showing the cutting blade being replaced with a rolling blade in accordance with the present invention.

FIGS. 14 and 15 are schematic views showing the replacement of the blade with a sawing blade and a diamond blade for cutting glass respectively in accordance with the present invention.

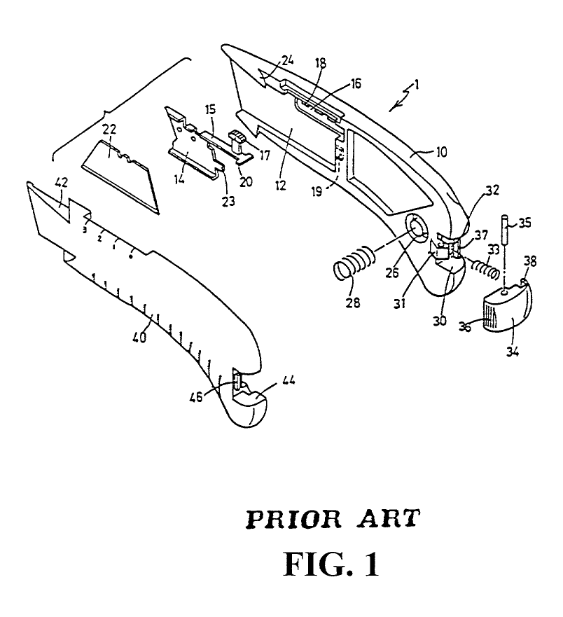

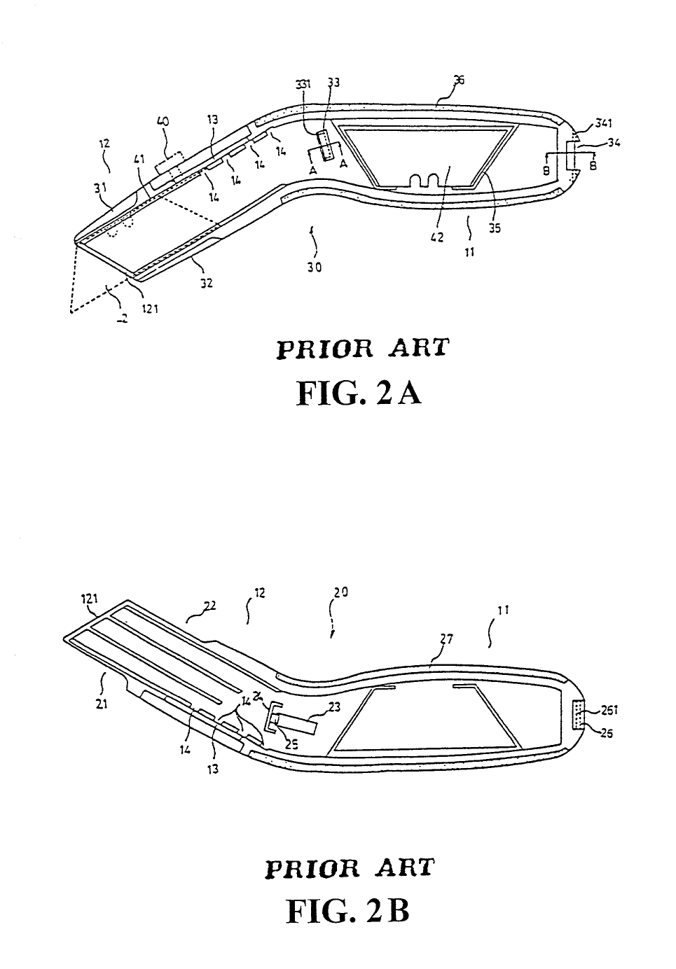

### DETAILED DESCRIPTION OF THE PREFERRED EMBODIMENT

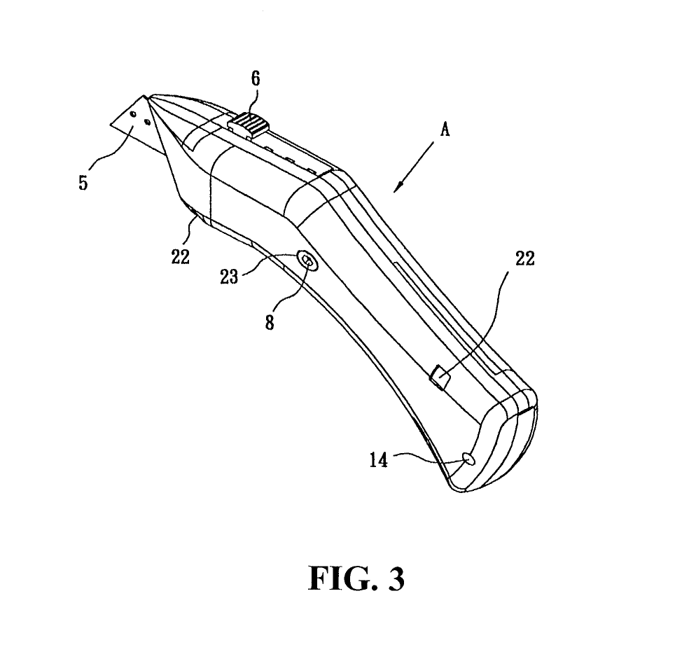

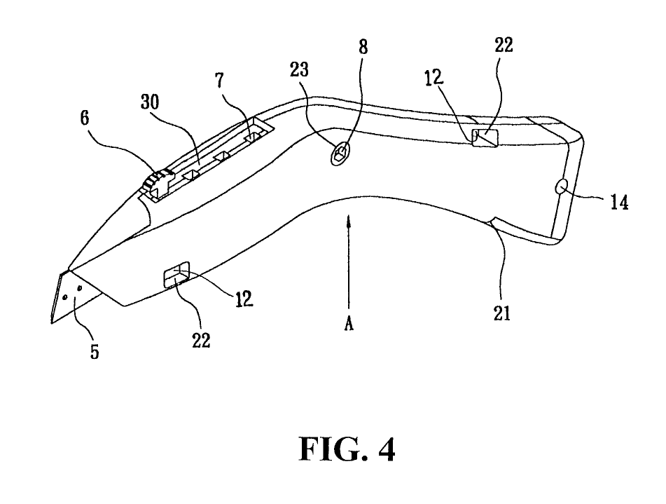

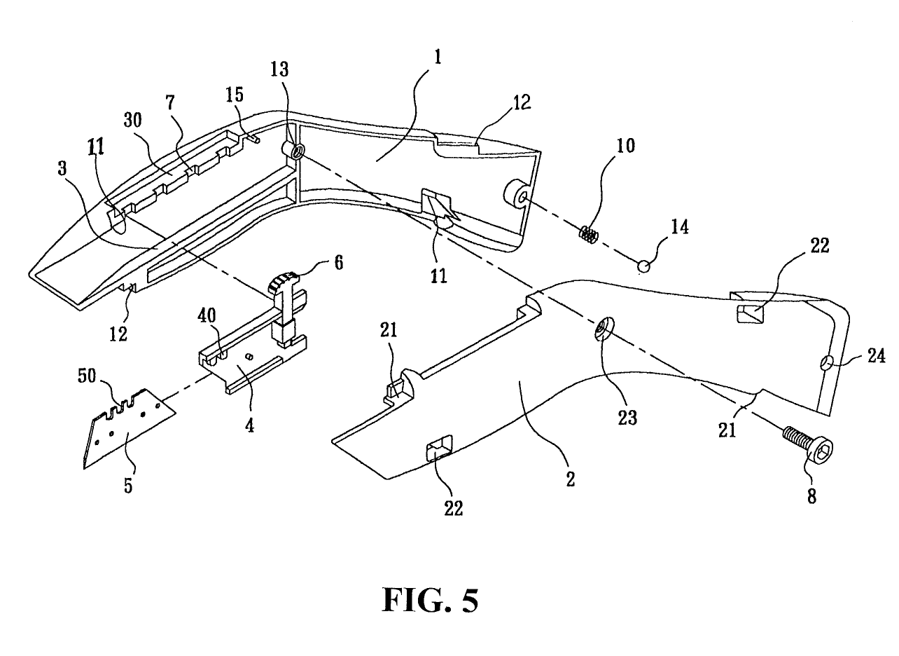

Referring to FIGS. 3, 4 and 5, there is shown an improved structure of a penknife A comprising a top housing 1, a bottom housing 2. A blade slot 3 is formed at a recess between the two housings 1, 2 for the mounting of a blade seat 4 and a blade 5. The top edge of the blade slot 3 is a sliding slot 30 to guide the sliding of the blade seat 4 by means of a push button 6. The edge at the end of the sliding slot 30 is engaging path 7 for engaging with one end of the push button 6 so that the blade 5 is either extended out or retracted in. These are two engaging teeth 40 at the top edge of the blade seat 4 to mount with the blade 5 at the blade notch 50.

In accordance with the present invention, the four corners of the top housing 1 are provided with two engaging recess 11 diagonally located at the end of the top housing 2 and two engaging protrusion 12 being diagonally located at the end by the top housing 1. The rear end of the top housing 1 is a round protrusion 14 having urged with a spring 10, and the middle section of the top housing 2 is a screw hole 13, and a pillar 15 is located close to the screw hole 13.

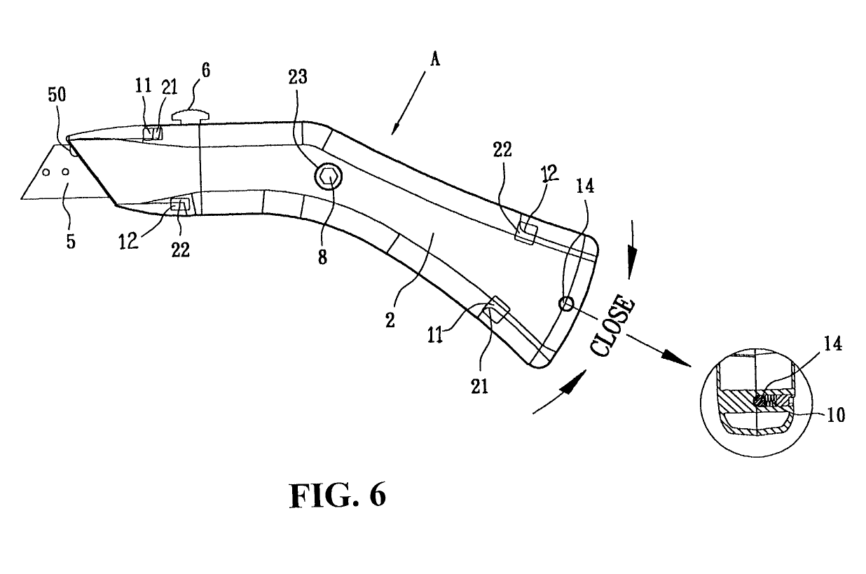

The four corners of the bottom housing 2 are provided with two engaging recess 21 and two engaging protrusion 22, each of the engaging recess 21 and the engaging protrusion 22 are diagonally mounted at the corners of the bottom housing 2. The engaging protrusions and the engaging recess of the 2. top housing 1 are in alignment with that of the bottom housing A screw hole 23 is provided to the center of the bottom housing 23 in alignment with the screw hole 13. A screw 8 is used to mount the top housing 1 and the bottom housing 2 together. The round protrusion 14 and the round recess 24 at the rear end of the top 1 and bottom housing 2 are fastened to each other (refer to FIG. 6).

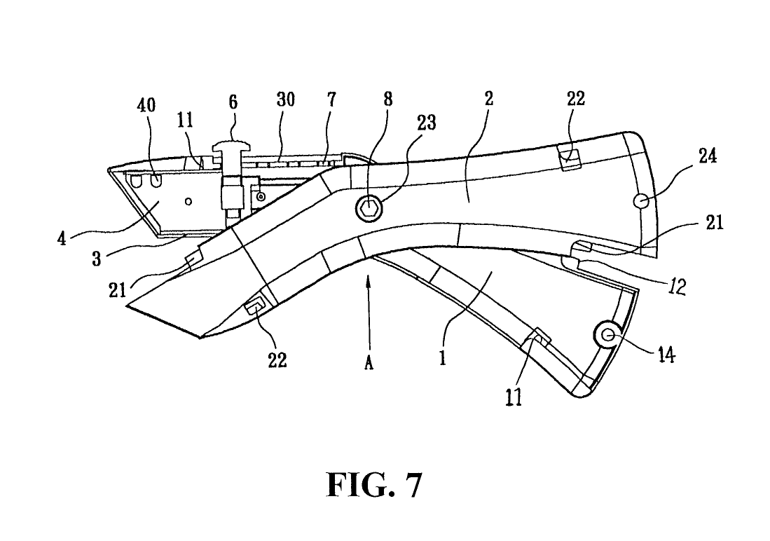

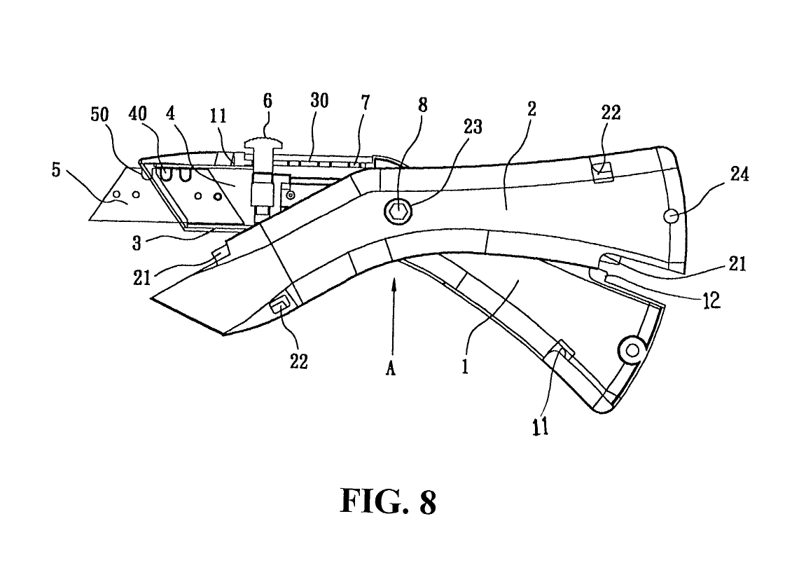

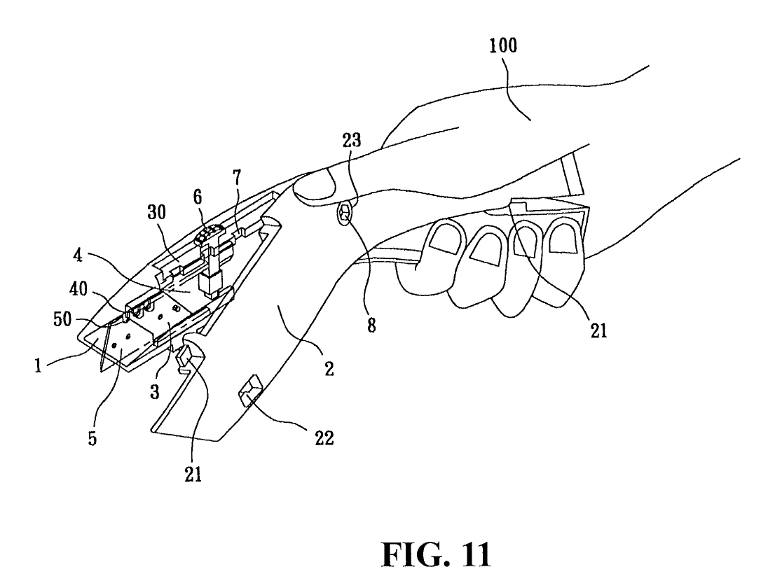

As shown in FIG. 11, if the rear end of the bottom housing 2 is pushed, the round recess 24 of the bottom housing 2 is disengaged from the round protrusion 14 of the top housing 1, and the front ends of the two housing 1, 2 are slightly opened, (as shown in FIGS. 7 and 8), and the blade seat is opened for replacement of blade 5 or for installation of blade 5.

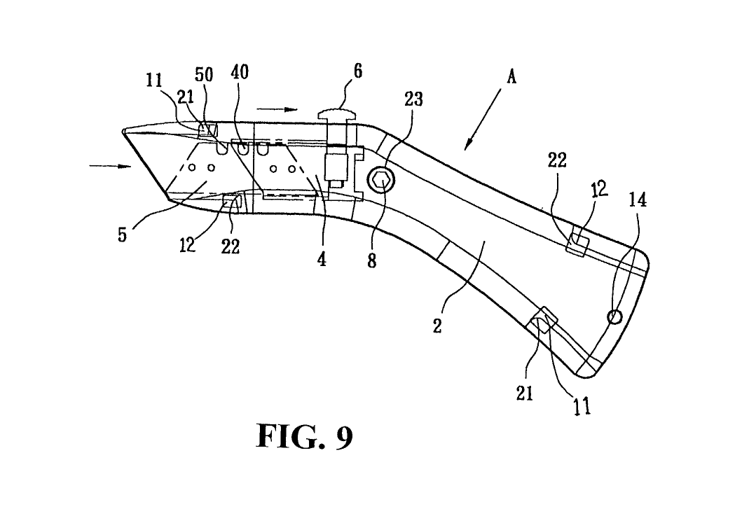

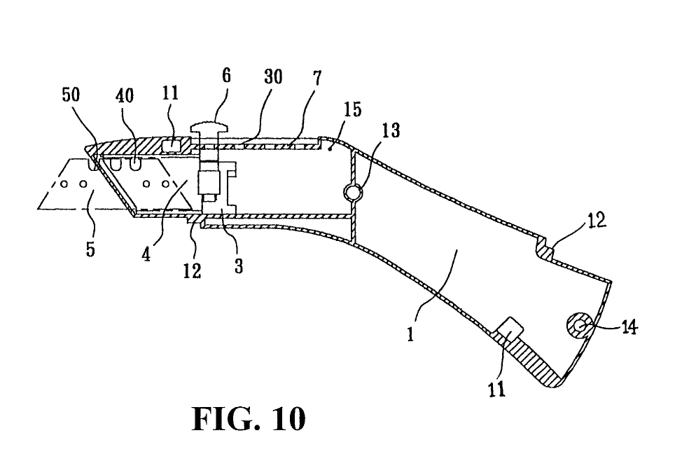

When the round recess 24 at the rear end of the bottom housing 2 is pushed tangentially to the round protrusion 14 at the rear end of the top housing 1, the two housings 1, 2 are fastened as shown in FIG. 9, and the blade 5 is mounted within the pen-knife A. FIG. 10 shows the blade 5 is pushed out from the penknife A.

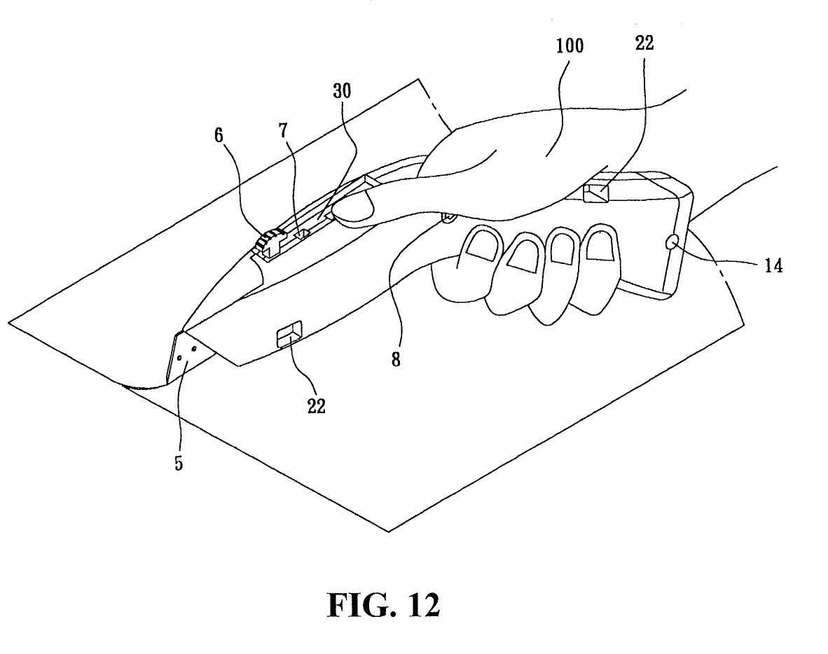

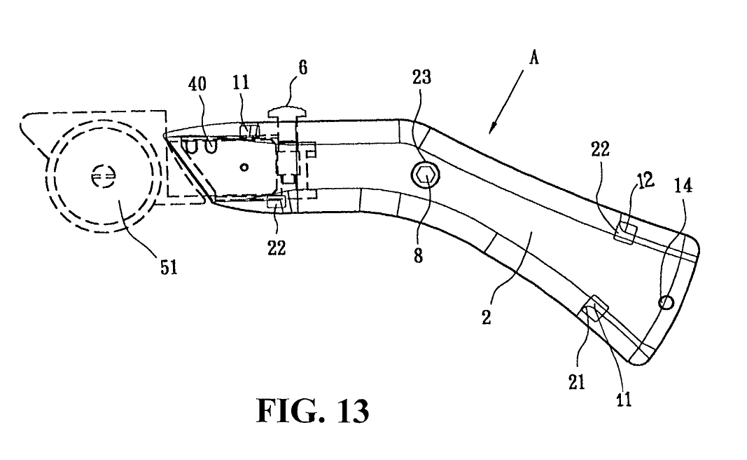

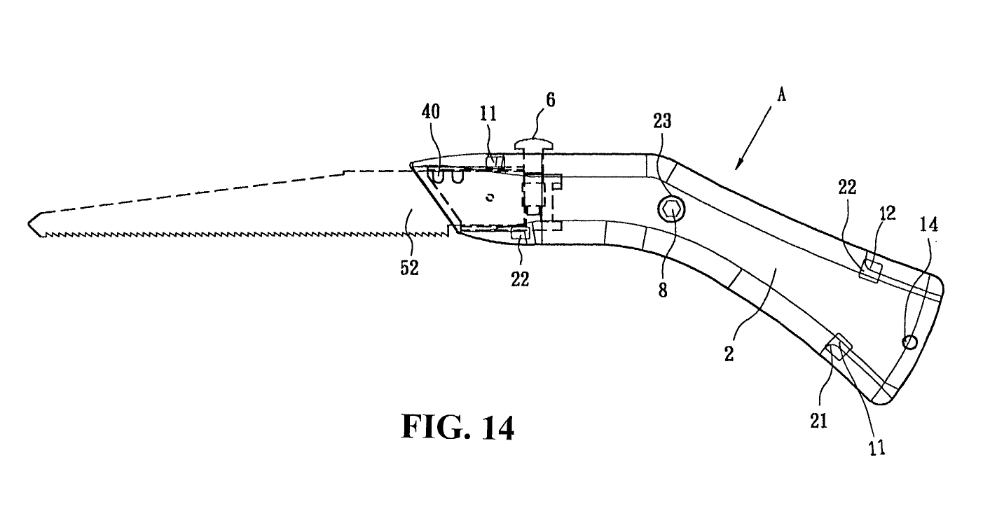

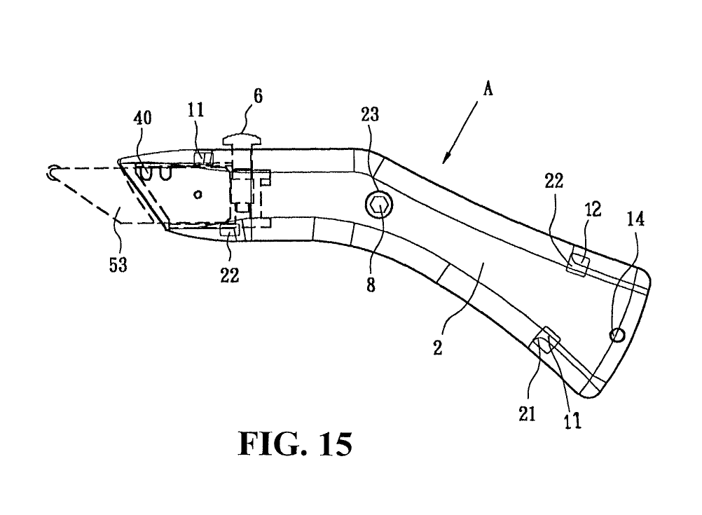

FIG. 12 shows the holding of the pen-knife A with blade 5 for cutting, and the blade 5 can be replaced by a rolling blade 51, as shown in FIG. 13, and the blade 5 can also be replaced with a sawing blade 52 as shown in FIG. 14. In FIG. 15, a diamond blade with an acute-angled tip is mounted to the tip of the blade 5 for cutting glass.

While this invention has been described in terms of a specific preferred embodiment, it is contemplated that various alterations and modifications thereof will become apparent to those skilled in the art. It is therefore intended that the appended claims included all such alterations and modifications as fall within the true spirit and scope of the present invention.

I claim:

1. An improved structure of a penknife comprising:
a top housing and a bottom housing being mounted together with a positioning screw at the center of the housings;
a knife seat having a push button and engaging teeth for engaging with a plurality of blade notches at the edge at one end of a blade;
four pairs of engaging recess and engaging button being provided at the four corners of the top housing and bottom housing and being engageable with each other;
characterized in that the end section of the top housing is provided with a round protrusion urged by a spring and a round recess is provided on the bottom housing at a position corresponding to the round protrusion, thereby a finger is used to press the rear end of the top housing so that the engaging recess and engaging buttons on the top and bottom housing are separated so that the housings of the front end of the pen-knife are crossed with each other, allowing installation of a blade or removal of a blade.

2. The structure as set forth in claim 1, wherein the blade is a cutting rolling blade.

3. The structure as set forth in claim 1, wherein the blade is a sawing blade.

4. The structure as set forth in claim 1, wherein the blade is mounted with a diamond blade having an acute angled tip.
